(19) United States
(12) Patent Application Publication
(10) Pub. No.: US 2011/0219767 A1
(43) Pub. Date: Sep. 15, 2011

(54) CONTROL DEVICE FOR INTERNAL COMBUSTION ENGINE EQUIPPED WITH TURBOCHARGER

(75) Inventor: Shigeki Miyashita, Shizuoka-ken (JP)

(73) Assignee: Toyota Jidosha Kabushiki Kaisha, Toyota-shi, Aichi-ken (JP)

(21) Appl. No.: 12/673,371

(22) PCT Filed: Aug. 8, 2008
(86) PCT No.: PCT/IB2008/002089

§ 371 Date: Feb. 12, 2010

(30) Foreign Application Priority Data
Aug. 13, 2007 (JP) 2007-211050

(51) Int. Cl. F02B 37/18

(52) U.S. Cl. 60/600

(57) ABSTRACT

A control device for an internal combustion engine including a turbocharger including a first exhaust channel leading to a turbine of the turbocharger, a second exhaust channel that does not lead to the turbine, a first exhaust valve that opens and closes the first exhaust channel, a second exhaust valve that opens and closes the second exhaust channel, and an exhaust variable valve mechanism that has a medium cam and a small cam as cams that drive the second exhaust valve and can change a lift amount and a working angle of the second exhaust valve by switching the cam profiles. The adjustment of the amount of exhaust energy supplied to the turbine and the adjustment of the turbine revolution speed and supercharge pressure are performed by switching the cam profiles of the second exhaust valve.

### BACKGROUND OF THE INVENTION

1. Field of the Invention

The present invention relates to a control device for an internal combustion engine equipped with a turbocharger.

2. Description of the Related Art

Japanese Patent Application Publication No. 10-89106 (JP-A-10-89106), for example, describes an internal combustion engine equipped with a turbocharger. This internal combustion engine has a first exhaust valve that opens and closes a first exhaust channel leading to a turbine and a second exhaust valve that opens and closes a second exhaust channel that does not lead to the turbine. In this internal combustion engine, in a high-speed region, the first exhaust valve is opened before the expansion stroke ends and the second exhaust valve is opened in the first half of the exhaust stroke. Further, this internal combustion engine has a waste gate valve for controlling the boost pressure and turbine revolution speed in the channel that bypasses the turbine of the turbocharger.

For example, Japanese Patent Application Publication No. 5-263671 (JP-A-5-263671) also describes an internal combustion engine equipped with a turbocharger. Similarly to the internal combustion engine described in JP-A-10-89106, this internal combustion engine also has a first exhaust valve that opens and closes a first exhaust channel leading to a turbine and a second exhaust valve that opens and closes a second exhaust channel that does not lead to the turbine. This internal combustion engine further has a hydraulic drive device for valves that serves to open and close the first exhaust valve and second exhaust valve in each cylinder independently from each other.

Although the control device disclosed in JP-A-10-89106 has a variable valve mechanism for independently driving the lift amount of the first exhaust valve and second exhaust valve, a waste gate valve is necessary for controlling the boost pressure and turbine revolution speed. Further, the hydraulic drive device for valves that is described in JP-A-5-263671 can perform a stageless adjustment of lift amount and working angle of the first exhaust valve and second exhaust valve, but a valve system having this function of the stageless adjustment of lift amount etc. requires complex component structure and control.

### SUMMARY OF THE INVENTION

The present invention provides a control device for an internal combustion engine equipped with a turbocharger that can control the amount of exhaust energy supplied to the turbocharger, without relying on a waste gate valve, while employing a simple valve system configuration.

An aspect of the present invention relates to a control device for an internal combustion engine equipped with a turbocharger. The control device for an internal combustion engine equipped with a turbocharger, where the internal combustion engine includes: a turbocharger that pressure-charges an intake air; a first exhaust channel connected to a turbine of the turbocharger; a first exhaust valve that opens and closes the first exhaust channel; a second exhaust channel that is not connected to the turbine; and a second exhaust valve that opens and closes the second exhaust channel. The control device for an internal combustion engine equipped with a turbocharger includes: an exhaust variable valve mechanism that can change a valve opening characteristic of one of the first exhaust valve and the second exhaust valve, that is the exhaust valve subjected to be switched; and control means for adjusting an amount of exhaust energy supplied to the turbine. The exhaust variable valve mechanism has a cam, that has a plurality of cam profiles, drives the exhaust valve subjected to be switched. The exhaust variable valve mechanism can switch the plurality of cam profiles in stages. The control means adjusts the amount of exhaust energy supplied to the turbine by switching the plurality of cam profiles.

According to the above-described aspect, the control of the amount of exhaust energy supplied to the turbine can be performed without relying on a waste gate valve, while realizing a cost reduction by employing a valve system configuration that is relatively simple by comparison with that in the case where a variable valve mechanism is provided that can continuously adjust the valve opening characteristic of the exhaust valve that is subjected to be switched.

In the above-described aspect, the internal combustion engine may further include: an exhaust bypass channel that bypasses the turbine and connects an inlet side of the turbine and an outlet side of the turbine, and a waste gate valve disposed in an intermediate section of the exhaust bypass channel. The control means may switch the , plurality of cam profiles so that an exhaust gas flow rate on the second exhaust channel side increases when an aperture of the waste gate valve is larger than a target aperture by a predetermined value or more.

According to the above-described aspect, the aperture can be controlled so as to maintain the aperture of the waste gate valve at a target aperture, while enabling both the exhaust flow rate adjustment by the switching of cam profiles and the exhaust flow rate adjustment by the aperture adjustment of the waste gate valve. Therefore, the decrease in energy recovery efficiency of the turbine caused by controlling the waste gate valve aperture to an excessively large value can be prevented and effective scavenging can be performed within a wide range of the operation region of the internal combustion engine.

In the above-described aspect, the control means may adjust at least one of a boost pressure and a turbine revolution speed by switching the plurality of cam profiles.

In the above-described aspect, the switching of the plurality of cam profiles in stages may be performed either in a plurality of stages or in a stageless manner.

According to the above-described aspect, the control of at least one of the turbine revolution speed and boost pressure can be performed without relying on a waste gate valve, while realizing a cost reduction by employing a valve system configuration that is relatively simple by comparison with that in the case where a variable valve mechanism is provided that can continuously adjust the valve opening characteristic of the exhaust valve that is an object of switching.

In the above-described aspect, the internal combustion engine may have a plurality of cylinders. The exhaust variable valve mechanism may have the plurality of cam profiles for each exhaust valve subjected to be switched in the each cylinder. The exhaust variable valve mechanism may be configured to be capable of switching the plurality of cam profiles in stages for the each cylinder. The control means may adjust an exhaust flow rate on the first exhaust channel side by changing the number of cylindersin which the switching of the plurality of cam profiles is performed.

In the above-described aspect, the switching of the plurality of cam profiles in stages may be performed in two stages.

In the above-described aspect, the plurality of cylinders may have the same plurality of cam profiles.

In the above-described aspect, the plurality of cylinders may have different plurality of cam profiles in at least two cylinders. The control means may adjust the exhaust flow rate on the first exhaust channel side by selecting the cylinders in which the switching of the plurality of cam profiles is performed, or by changing the number of cylinders.

According to the above-described aspect, the exhaust variable valve mechanism can be, configured to have a large number of stages for adjusting the exhaust flow rate, while reducing the number of stages for switching the cam, profile to simplify the structure. Therefore, even when the exhaust variable valve mechanism with a small number of switching stages is used, it is possible to perform a fine adjustment of the amount of exhaust energy supplied to the turbine, such as the exhaust gas pressure and exhaust flow rate, and also fine adjustment of turbine revolution speed, and fine adjustment of boost pressure. As a result, the performance of the internal combustion engine and operability during pressure-charge operation can be improved.

In the above-described aspect, the internal combustion engine may further include an intake variable valve mechanism that can change a valve opening characteristic of an, intake valve. The control means may perform an adjustment of an intake air amount to the internal combustion engine by using the intake variable valve mechanism, simultaneously with the switching of the plurality of cam profiles.

In the above-described aspect, the intake variable valve mechanism may control any one or more from among an opening-closing timing, a lift amount, and a working angle of the intake valve.

According to the above-described aspect, by adjusting the valve opening characteristic of the intake valve by the intake variable valve mechanism simultaneously with the switching of cam profiles of the cams that drive the exhaust valve that is an object of switching, it is possible to impart the intake air amount control with continuity even though cam profiles are switched. Therefore it is possible to adjust the intake air amount so as to cancel a variety of effects such as the decrease in the boost pressure caused by such switching of cam profiles, variations in pump loss caused by back pressure variations, and variations in combustion state that accompany variations in residual gas amount. As a result, the performance of the internal combustion engine and operability during pressure-charge operation can be improved.

In the above-described aspect, the exhaust variable valve mechanism may be further configured to be capable of changing a closing timing of at least one of the first exhaust valve and the second exhaust valve. The control means may perform an adjustment of a valve overlap period by using the exhaust variable valve mechanism so that at least one of a residual gas amount and scavenge amount inside a cylinder are maintained at a fixed value when the adjustment of the intake air amount using the intake variable valve mechanism is implemented.

In the above-described aspect, the exhaust variable valve mechanism may be further configured to be capable of changing an opening-closing timing of at least one of the first exhaust valve and the second exhaust valve. The control means may perform an adjustment of a valve overlap period by using the exhaust variable valve mechanism so that at least one of a residual gas amount and scavenge amount inside a cylinder are maintained at a fixed value when the adjustment of the intake air amount using the intake variable valve mechanism is implemented.

In the above-described aspect, the exhaust variable valve mechanism may be further configured to be capable of changing an opening-closing timing of at least one of the first exhaust valve and the second exhaust valve. The intake variable valve mechanism may be also configured to be capable of changing an opening-closing timing of the intake valve. The control means may perform an adjustment of a valve overlap period so that at least one of a residual gas amount and scavenge amount inside a cylinder are maintained at a fixed value when the adjustment of the valve overlap period using the intake variable valve mechanism and the exhaust variable valve mechanism is implemented.

According to the above-described aspect, at least one of the residual gas amount and scavenge amount can be controlled to a fixed value by also controlling the valve opening characteristic of the exhaust gas when the adjustment of the valve opening characteristic of the intake valve with the intake variable valve mechanism is performed simultaneously with the switching of cam profiles of the cams that drive the exhaust valve that is subjected to be switched. As a result, in contrast with a procedure in which variations in the residual gas amount or variations in scavenge amount are canceled by adjusting the intake air amount, prevents the spread between individual parts and spread of operating conditions. Therefore, variations in combustion state during switching of cam profiles can be effectively inhibited.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 illustrates a system configuration in a first embodiment of the present invention;

FIG. 2 illustrates a specific configuration of a cam switching mechanism contained in the exhaust variable valve mechanism shown in FIG. 1;

FIGS. 3A and 3B illustrate specific configurations of a cam switching mechanism contained in the exhaust variable valve mechanism shown in FIG. 1;

FIG. 4 represents a lift curve of an exhaust valve realized with the exhaust variable valve mechanism shown in FIG. 1;

FIG. 5 is a flowchart of a routine executed in the first embodiment of the present invention;

FIG. 6 illustrates schematically the configuration of a hydraulic control unit in a system of a second embodiment of the present invention;

FIGS. 7A to 7D illustrate specific switching control of cam profiles in the second embodiment of the present invention;

FIG. 8 is a flowchart of a routine executed in the second embodiment of the present invention;

FIG. 9 is a flowchart of a routine executed in a third embodiment of the present invention;

FIGS. 10A to 10E are a time chart representing an example of process in step 302 of the routine shown in FIG. 9;

FIG. 11 is a flowchart of a routine executed in a fourth embodiment of the present invention;

FIGS. 12A to 12E are a time chart representing an example of process in step 400 of the routine shown in FIG. 11;

FIG. 13 illustrates a system configuration in a fifth embodiment of the present invention; and

FIG. 14 is a flowchart of a routine executed in the fifth embodiment of the present invention.

### DETAILED DESCRIPTION OF EMBODIMENTS

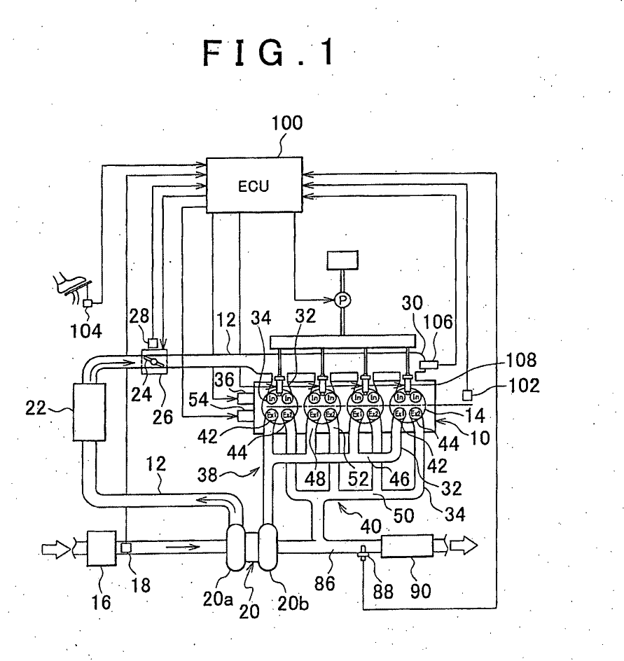

FIG. 1 shows a system configuration of a first embodiment of the present invention. The system shown in FIG. 1 includes an internal combustion engine 10 having four cylinders.

An air intake system of the internal combustion engine 10 has an air intake channel 12. The air is taken in from the atmosphere to the air intake channel 12 and distributed between combustion chambers 14 of the cylinders. An air cleaner 16 is mounted on an inlet port of the air intake channel 12. An air flowmeter (AFM) 18, which outputs a signal corresponding to the flow rate Of the air taken into the air intake channel 12, is provided in the vicinity of the downstream of the air cleaner 16.

A turbocharger 20 is provided downstream of the air flowmeter 18. The turbocharger 20 has a centrifugal compressor 20a and a turbine 20b. An intercooler 22 for. cooling the compressed air is provided downstream of the compressor 20a. A throttle valve. 24 is disposed downstream of the intercooler 22. The throttle valve 24 is electrically operated and that is driven by a throttle motor 26 based on an accelerator aperture.

A throttle position sensor 28 for detecting a throttle aperture TA is disposed in the vicinity of the throttle valve 24. The intake air that has passed through the throttle valve 24 is distributed by an air intake manifold 30 to air intake ports 32 of the cylinders. An intake valve 34 is provided in each air intake port 32 of the cylinders.

The intake valve 34 is open-closed by an intake variable valve mechanism 36. Here, the intake variable valve mechanism 36 is assumed to have a VVT mechanism (not shown in the figure) that can continuously change (can change an opening-closing timing, without changing the working angle) an open valve phase of the intake valve 34 of the each cylinder. However, the intake variable valve mechanism 36 is not limited to such VVT mechanism, provided that it can change valve opening characteristics (lift amount, working angle, opening timing, closing timing and the like) of the intake valve 34 in order to adjust the intake air amount, and may also be any conventional mechanical variable valve mechanism that can continuously change the lift amount of working angle of the intake valve 34.

An exhaust system of the internal combustion engine 10 has two exhaust channels, that is, a first exhaust channel 38 and a second exhaust channel 40. More specifically, the turbine 20b of the turbocharger 20 is disposed in the intermediate section of the first exhaust channel 38. The second exhaust channel 40 is configured to merge with the first exhaust channel 38 downstream of the turbine 20b. In other words, the first exhaust channel 38 is configured as an exhaust channel connected to the turbine 20b, and the second exhaust channel 40 is configured as an exhaust channel that is not connected to the turbine 20b.

A first exhaust valve 42 and a second exhaust valve 44 are provided in the each cylinder. The first exhaust channel 38 is branched by a first exhaust manifold 46 and connected to a first exhaust port 48 where the first exhaust valve 42 of the each cylinder is disposed. Further, the second exhaust channel 40 is branched by a second exhaust manifold 50 and connected to a second exhaust port 52 where the second exhaust valve 44 of the each cylinder is disposed. In other words, the first exhaust valve 42 is configured as an exhaust valve that opens and closes the first exhaust channel 38, and the second exhaust valve 44 is configured as an exhaust valve that opens and closes the second exhaust channel 40.

The first exhaust valve 42 and second exhaust valve 44 are open-closed by an exhaust variable valve mechanism 54. Here, the exhaust variable valve mechanism 54 is assumed to have a VVT mechanism similar to the intake variable valve mechanism 36 as a mechanism for continuously changing an open valve phase of the first exhaust valve 42 and second exhaust valve 44 of the each cylinder. Further, the exhaust variable valve mechanism 54 has in the each cylinder a cam switching mechanism 56 for independently changing the lift amount and working angle of the first exhaust valve 42 and second exhaust valve 44.

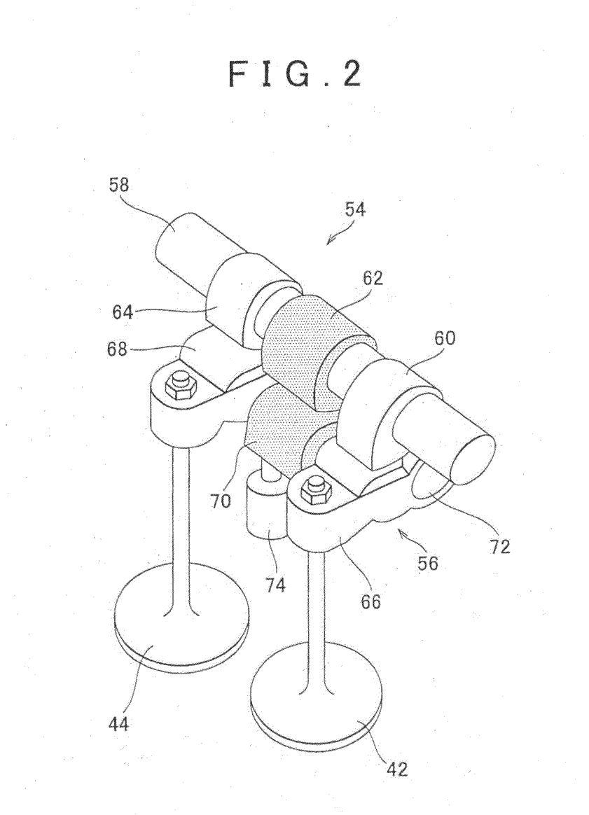

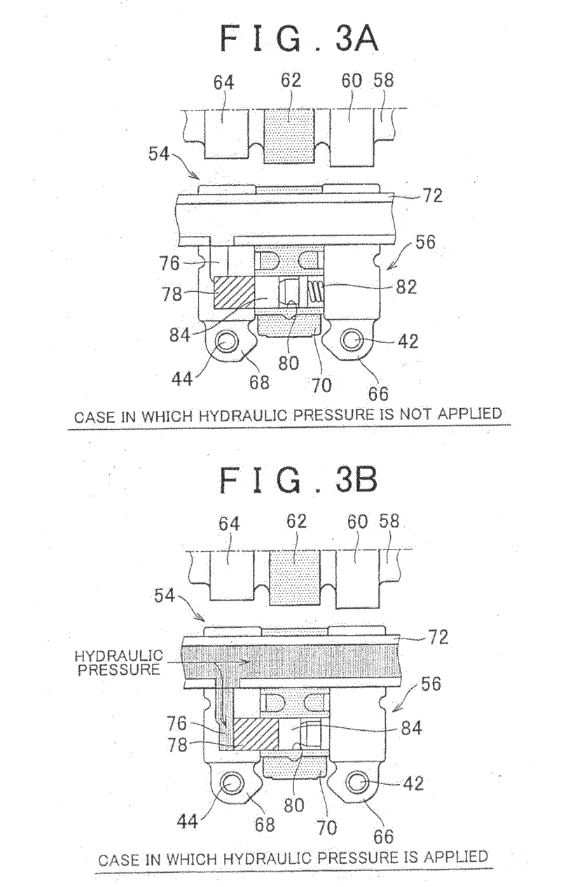

FIGS. 2, 3A, and 3B illustrate specific configurations of the cam switching mechanism 56 provided in the exhaust variable valve mechanism 54 shown in FIG. 1. More specifically, FIG. 2 is a perspective view of the first exhaust valve 42, second exhaust valve 44, and exhaust variable valve mechanism 54. FIGS. 3A and 3B are cross sectional views of the main portions of the cam switching mechanism 56. As shown in FIG. 2, the exhaust variable valve mechanism 54 has an exhaust cam shaft 58. Three cams 60, 62, 64 are provided, at the each cylinder, on the exhaust cam shaft 58. More specifically, a large cam 60 is a cam for driving the first exhaust valve 42, and a medium cam 62 and a small cam 64 are cams for driving the second exhaust valve 44.

The medium cam 62 has a cam profile providing a lift amount and working angle that are smaller than those of the large cam 60. The small cam 64 has a cam profile providing a lift amount and working angle that are smaller than those of the medium cam 62.

A first rocker arm 66 is disposed below the large cam 60, and a second rocker arm 68 is disposed below The small cam 64. A third rocker arm 70 is disposed between the two rocker arms 66, 68. These three rocker arms 66, 68, 70 are rotatably supported, at one end thereof, by a rocker shaft 72 disposed parallel to the exhaust cam shaft 58. Further, the other end of the first rocker aim 66 and the other end of the second rocker arm 68 are supported by the first exhaust valve 42 and second exhaust valve 44. Further, the third rocker arm 70 is biased at the other end thereof by a lost motion spring 74 toward the medium cam 62.

As shown in FIGS. 3A and 3B, a hydraulic chamber 76 is formed inside the second rocker arm 68, and a pin 78 is inserted into the hydraulic chamber 76. Inside the rocker shaft 72 functions as a hydraulic channel, and a working oil is supplied from the rocker shaft 72 into the hydraulic chamber 76. A hydraulic pressure supplied to the hydraulic chamber 76 of the each cylinder is controlled by an oil control valve (not shown in the figure) that is disposed in the hydraulic channel (not shown in the figure).

On the other hand, a pin hole 80 having an opening on the side of the second rocker arm 68 is formed in the third rocker arm 70. A return spring 82 and a piston 84 are disposed inside the pin hole 80 from the bottom end thereof. Such pin 78 and pin hole 80 are disposed on the same circular arc for which the rocker shaft 72 serves as the center.

With the above-described configuration, when the position of the pin hole 80 matches the position of the pin 78, the pin 78 abuts against the piston 84. In this case, where a force by which the hydraulic pressure within the hydraulic chamber 76 pushes the piston 78 is larger than the force by which the return spring 82 pushes the piston 84, the pin. 78 advances into the pin hole 80, while pushing the piston 84 deeper into the pin hole 80. When the pin 78 is inserted into the pin hole 80, the second rocker arm 68 and third rocker arm 70 are joined via the pin 78.

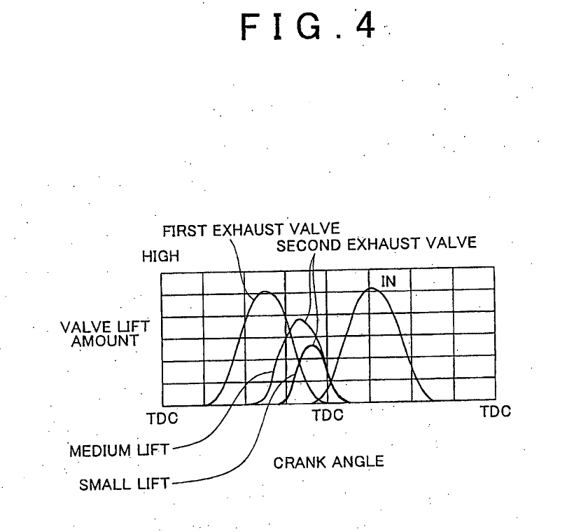

FIG. 4 illustrates lift curves of the first exhaust valve 42 and second exhaust valve 44 operated by the exhaust variable valve mechanism 54 shown in FIG. 1. With the exhaust variable valve mechanism 54 having the above-described cam switching mechanism 56, the lift amount and working angle of the second exhaust valve 44 can be adjusted in two stages independently, that is separately from the first exhaust valve 42.

More specifically, when the second rocker arm 68 and third rocket arm 70 are not joined by the pin 78, the small cam 64 is selected as a cam that drives the second exhaust valve 44. In this case, as shown in FIG. 4, the first exhaust valve 42 is controlled by the large cam 60 at a large lift amount and large working angle, and the second exhaust valve 44 is controlled by the small cam 64 at a small lift amount and small working angle.

On the other hand, when the second rocker arm 68 and third rocker arm 70 are joined by the pin 78, the medium cam 62 is selected as a cam that drives the second exhaust valve 44. Therefore, in this case, as shown in FIG. 4, the first exhaust valve 42 is not affected, but the second exhaust valve 44 is controlled to a lift amount (referred to hereinbelow as “medium lift amount”) and working angle larger than those in the case where the small cam 64 is selected.

The system configuration of the present embodiment will be explained below with reference to the same FIG. 1. An air-fuel ratio sensor 88 for detecting an exhaust air-fuel ratio is provided in a post-merging exhaust, channel 86 downstream of the merging point of the first exhaust channel 38 and second exhaust channel 40. A catalyst 90 for exhaust gas purification is provided downstream of the air-fuel ratio sensor 88.

A control system of the internal combustion engine 10 has an Electronic Control Unit (ECU) 100. In addition to the above-described sensors, a crank angle sensor 102 for detecting the engine revolution speed, an accelerator position sensor 104 for detecting the accelerator aperture, and an air intake pressure sensor 106 for detecting the intake air pressure are connected to the ECU 100. Further, in addition to the above-described actuators, fuel injection valves 108 for injecting fuel into combustion chambers 14 of the cylinders are connected to the ECU 100. The ECU 100 controls the operational state of the internal combustion engine 10 based on the outputs of these sensors.

The system of the present embodiment that has the above-described configuration does not have an exhaust bypass channel that bypasses the turbine 20b of the turbocharger 20 and, therefore, has no waste gate valve. In the present embodiment, the adjustment of the amount of exhaust energy (exhaust pressure or exhaust flow rate) for adjusting the revolution speed of the turbine 20b is performed by changing in stages the profile of the cam (small cam 64, medium cam 62) that drives the second exhaust valve 44 with the above-described exhaust variable valve mechanism 54, without relying on the waste gate valve.

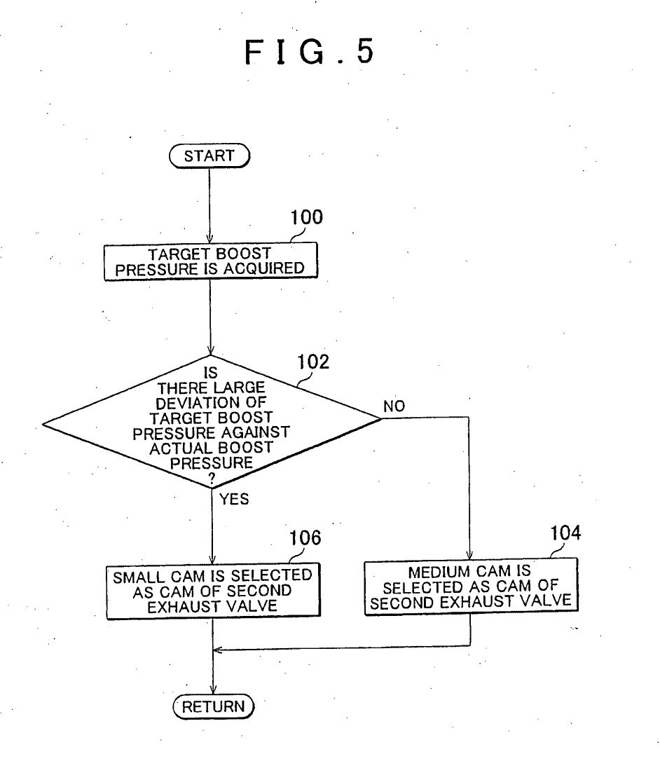

FIG. 5 is a flowchart of a routine implemented by the ECU 100 in the first embodiment in order to realize the above-described functions. In the routine shown in FIG. 5, the ECU 100, first, acquires a target boost pressure of the internal. combustion engine 10 (step working angle). More specifically, the ECU 100 stores a map (not shown in the figure) that determines the target boost pressure in relation with the operational state (load rate and engine revolution speed) of the internal combustion engine 10, and the target boost pressure is acquired in this step 100 with reference to such a map.

Then, the ECU 100 determines whether the deviation of the target boost pressure acquired in the step 100 against the actual boost pressure determined by an air intake pressure sensor 106 is larger than a predetermined threshold (step 102). As a result, when it is determined that the deviation of the boost pressure is equal to or less than the threshold (No in the step 102), that is, when it is determined that the actual boost pressure has been controlled to a value that is comparatively close to the target boost pressure, the ECU 100 selects the profile of the medium cam 62 as the profile of the cam that drives the second exhaust valve 44 (step 104).

On the other hand, when it is determined in the step 102 that the deviation of the boost pressure is larger than the threshold (Yes in the step 102), that is, when it is determined that the actual boost pressure has not fully reached a value close to the target boost pressure, the ECU 100 switches the cam profile that drives the second exhaust valve 44 to the profile of the small cam 64 (step 106).

With the above-described routine shown in FIG. 5, the cam profile that drives the second exhaust valve 44, which opens and closes the second exhaust channel 40, which is not connected to the turbine 20b, is controlled in two stages based on the deviation of the target boost pressure against the actual boost pressure. As a result, for example, when the lift amount of the second exhaust valve 44 has been changed from the medium lift amount to the small lift amount, the flow rate of the exhaust gas released through the second exhaust valve 44. is restricted. Therefore, the flow rate of the exhaust gas that is released through the first exhaust valve (42), that is, the flow rate of the exhaust gas introduced to the turbine 20b, can be increased with respect to the medium lift control.

Therefore, with the process of the above-described routine, the characteristic representing the variations in the amount of exhaust energy supplied to the turbine 20b is controlled in two stages corresponding to the operational state of the internal combustion engine 10. As a result, the adjustment of the revolution speed of the turbine 20b can be performed in stages and the adjustment of the boost pressure can be performed in stages. As described hereinabove, with the system of the present embodiment, the control of the amount of exhaust energy supplied to the turbine 20b as well as the turbine revolution speed and boost pressure can be performed without relying on a waste gate valve, while realizing cost reduction by employing a valve system configuration that is relatively simple in comparison with that in the case where a variable valve mechanism is provided that adjusts the valve opening characteristic of the exhaust valve in a stageless manner.

In the above-described the first embodiment, the example is explained in which a mechanism, that switches the cam profile that drives the second exhaust valve 44 in two stages, is employed as an exhaust variable valve mechanism. However, the exhaust variable valve mechanism according to the present invention is not limited to a mechanism that performs switching between two Stages, provided that the cam Profile of at least one of the exhaust valve from among aplurality of exhaust valves disposed in the each cylinder can be changed in a stepwise manner in several stages. Thus, the exhaust variable valve mechanism may switch the cam profile in three stages, for example, so that the lift amount of the second exhaust valve may be changed in a medium lift amount, a small lift amount, and a zero lift in a stepwise manner.

In the above-described first embodiment, the second exhaust valve 44 may be equivalent to “an exhaust valve that is an object of switching” according to the present invention, and the ECU 100 implements the process of the above-described routine shown in FIG. 5 may be equivalent to “control means” according to the present invention.

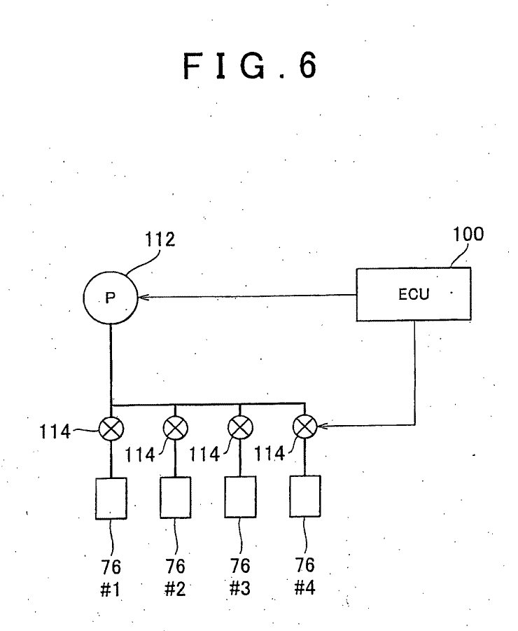

A second embodiment of the present invention will be explained below with reference to FIGS. 6 to 8. The system of the present embodiment is configured in the same manner as the above-described system of the first embodiment, except for the features described below with reference to FIG. 6.

FIG. 6 illustrates, in a simple manner, the configuration of a hydraulic control unit in the system of the second embodiment of the present invention. As shown in FIG. 6, the working oil is supplied from a hydraulic pump 112 via a hydraulic channel 110 to a hydraulic chamber 76 of an exhaust variable valves mechanism 54 of the each cylinder. In the present embodiment, an oil control valve 114 for ON/OFF controlling the supply of the working oil to the hydraulic chamber 76 is provided on the each cylinder. With such configuration, a cam profile of the second exhaust valve 44 can be switched separately for the each cylinder.

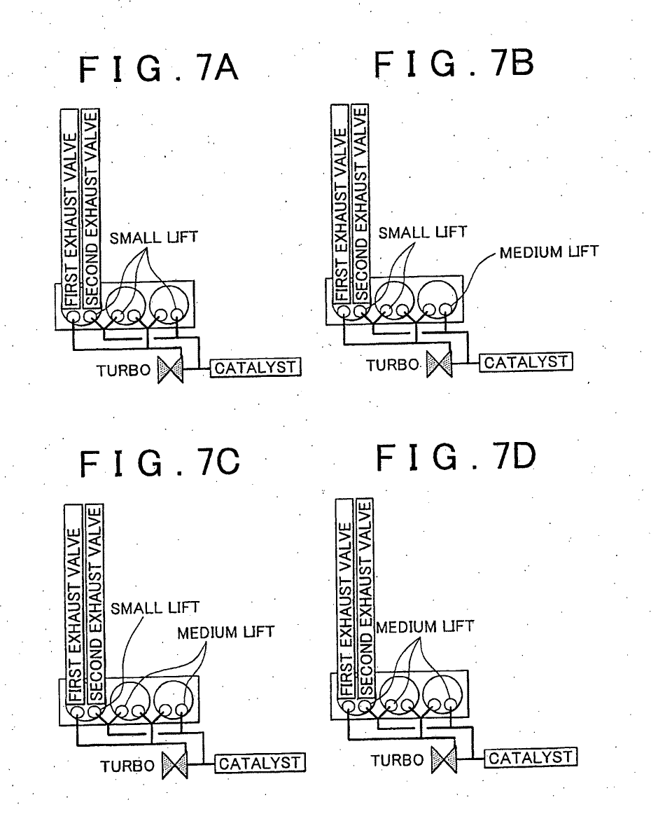

As described above, with the system of the present embodiment, the lift amount of the second exhaust valve 44 can be switched between the small lift amount and the medium lift amount for the each cylinder separately. In the present embodiment, the number of cylinders in which the profiles of the cams 62, 64 driving the second exhaust valve 44 are changed corresponding to the operational state of the internal combustion engine 10, more specifically, according to the deviation of the target boost pressure against the actual boost pressure. FIGS. 7A to 7D illustrate switching control of the cam profiles in the second embodiment of the present invention. To simplify the explanation, in FIGS. 7A to 7D a case will be explained in which the number of cylinders is three. Where the exhaust variable valve mechanism 54 switching the cams 62, 64 in two stages, which drive the second exhaust valve 44, is provided, as in the present embodiment, the lift amount of the second exhaust valve 44 of the each cylinder can be controlled in four modes shown in FIGS. 7A to 7D.

More specifically, as shown in FIG. 7A, the lift amount of second exhaust valves 44 of all the cylinders can be set to the small lift amount by selecting the small cam 64 in all the cylinders (three cylinders in the example illustrated by FIGS. 7A. to 7D).

Further, as shown in FIG. 7B, the lift amount of the second exhaust valves 44 of two cylinders can be set to the small lift amount and the second exhaust valve 44 of the remaining one cylinder can be set to the medium lift amount by selecting the small cam 64 in two cylinders and selecting the medium cam 62 in the remaining one cylinder.

As shown in FIG. 7C, the lift amount of the second exhaust valve 44 of one cylinder can be set to the small lift amount and the second exhaust valves 44 of the remaining two cylinders can be set to the medium lift amount by selecting the small cam 64 in one cylinder and selecting the medium cam 62 in the remaining two cylinders. Furthermore, as shown in FIG. 7D, the lift amount of the second exhaust valves 44 of all the cylinders can be set to the medium lift by selecting the medium cam 62 in all. the cylinders (three cylinders in the example illustrated by FIGS. 7A to 7D).

As a result, the flow rate of exhaust ^{.}gas introduced in the turbine 20b can be arranged in the following decreasing order FIG. 7A, FIG. 7B, FIG. 7C, FIG. 7D. In other words, when the lift amount of the second exhaust valve 44 is to be adjusted for the each cylinder separately, the number of stages for adjusting the exhaust flow rate can be increased to four stages even when the exhaust variable valve mechanism 54 has a function of switching the lift amount of the second exhaust valve 44 in two stages only. In addition, in the case of the internal combustion engine 10, which is an inline four-cylinder engine, as shown in FIG. 1, the number of stages for adjusting the exhaust. flow rate can be made five by adding one more cylinder. Furthermore, for example, when the exhaust variable valve mechanism 54 is configured as a mechanism that changes the adjustment of the lift amount of the second exhaust valve 44 to the adjustment in three stages including the zero lift, the number of stages for adjusting the exhaust flow rate can be further increased.

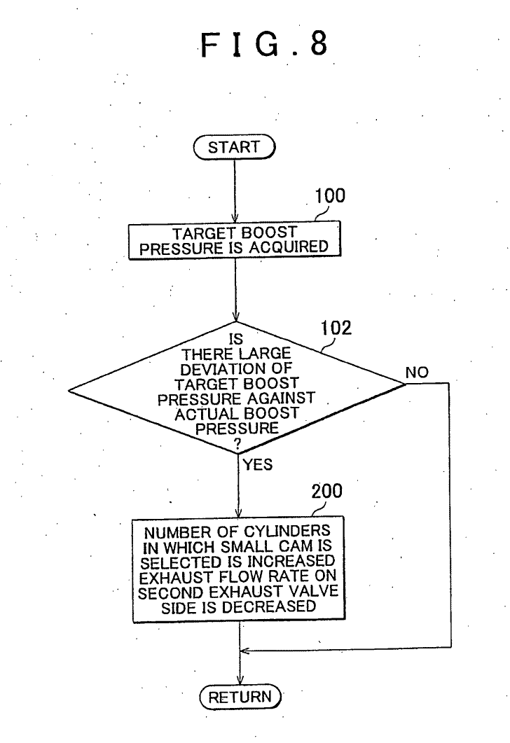

FIG. 8 is a flowchart of a routine implemented by the ECU 100 in the second embodiment in order to realize the above-described functions. In FIG. 8, the steps identical to the steps shown in FIG. 5 are assigned with identical reference numerals and the explanation thereof is omitted or simplified. When the ECU 100 determines in step 102 that the above-described deviation of the boost pressure is larger than the threshold (Yes in the step 102), the ECU 100 controls the exhaust variable valve mechanism 54 so as to increase the number of cylinders in which the small cam 64 is selected (in other words, so as to increase the number of cylinders in which the second exhaust valve 44 is controlled to the small lift amount) (step 200).

More specifically, in the example shown in FIGS. 7A to 7D, in the present step 200, the ECU 100 increases the number of cylinders in which the second exhaust valve 44 controlled to the small lift amount is present, in the direction from the control state shown in FIG. 7D to that shown in FIG. 7A. The number of cylinders in which the second exhaust valve 44 is controlled to the small lift amount may be determined based on the amount of deviation of the boost pressure.

With the above-described routine shown in FIG. 8, when it is determined that the actual boost pressure has not yet fully reached the target boost pressure, the number of the cylinders in which the small cam 64 is selected as the cam that drives the second exhaust valve 44 is appropriately increased, thereby increasing the flow rate of the exhaust gas introduced into the turbine 20b. With such a procedure, the number of stages for adjusting the exhaust flow rate can be increased, while decreasing the number of switching stages of the cam profile to simplify the structure, in the configuration of the exhaust variable valve mechanism 54. Therefore, even when the exhaust variable valve mechanism 54 with a small number of switching stages is used, it is possible to perform fine adjustment of the amount of exhaust energy supplied to the turbine, such as the . exhaust gas pressure and exhaust flow rate, as well as fine adjustment of turbine revolution speed and fine adjustment of boost pressure. As a result, the performance of the internal combustion engine 10 and operability during boost operation can be improved.

In the present embodiment, a plurality of cam profiles, that is the lift amounts, are identical in all the cylinders, and the exhaust flow rate is adjusted by changing the number of cylinders in which the cam profile changes. However, it is also possible to change a plurality of cam profiles, that is the lift amounts, in at least two or more cylinders. In this case, the exhaust flow rate can be adjusted by selecting not only the number of cylinders in which the cam profile changes, but also by selecting a cylinder in which the cam profile changes or selecting a combination of cylinders.

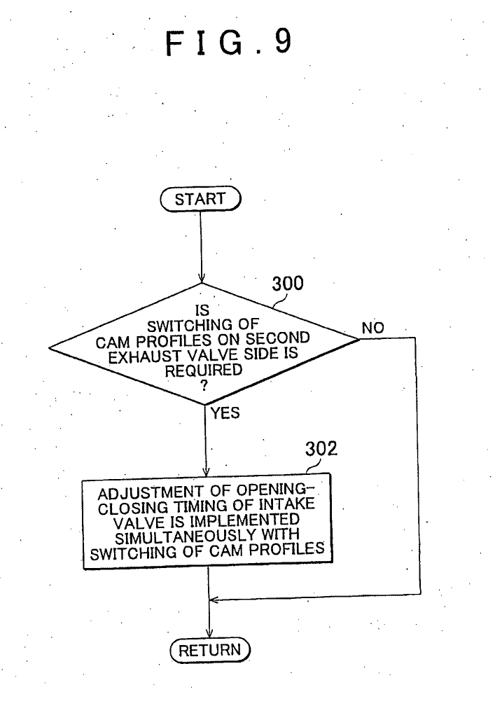

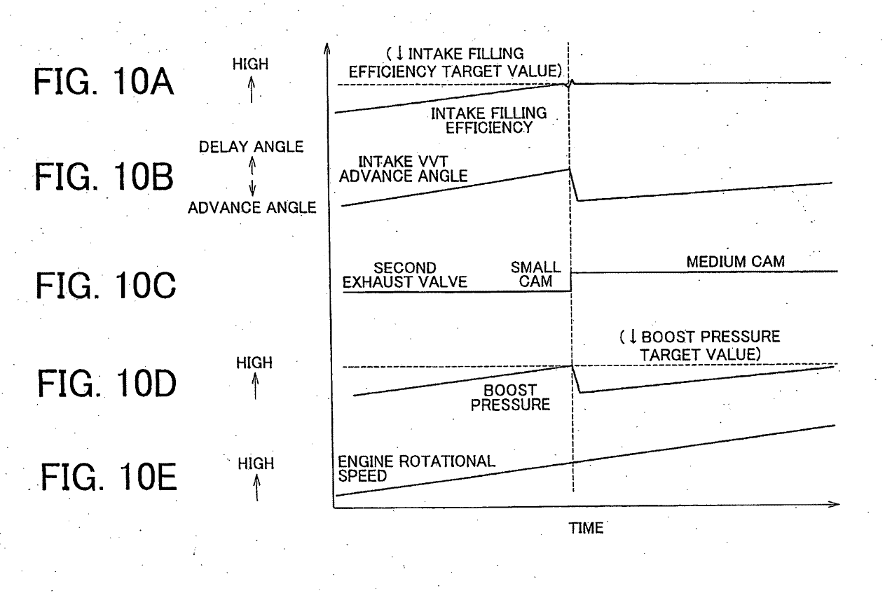

A third embodiment of the present invention will be explained below with reference to FIGS. 9 and 10. A system of the present embodiment uses the hardware configuration shown in FIGS. 1 to 3A and 3B and can operate by executing the routine shown in FIG. 5 or 8 and also the below-described routine shown in FIG. 9 in the ECU 100.

With the control of the above-described the first embodiment, the adjustment of the flow rate of exhaust gas supplied to the turbine 20b can be performed by switching the cam profile, but the adjustment amount of the exhaust flow rate is restricted by the number of switching stages of the cam profile in the exhaust variable valve mechanism 54. Further, with the control of the above-described the second embodiment, the adjustment margin of the exhaust flow rate can be enlarged by comparison with that of the control of the first embodiment, but the problem is that there may still a region in which the flow rate adjustment is impossible.

In order to ensure the operability of the internal combustion engine 10, the continuity of output values of the internal combustion engine 10 may be ensured even when the continuity of turbine revolution speed or boost pressure is not maintained, and the continuity of the intake air amount and the like may be ensured for this purpose.

Accordingly, in the present embodiment, when the cam profile of the second exhaust valve 44 is switched to adjust the boost pressure or the like, the advance angle amount of opening-closing timing of the intake valve 34 is controlled by the intake variable valve mechanism 36 simultaneously with the switching of the cam profiles.

FIG. 9 shows a flowchart of the routine implemented by the ECU 100 in the.

third embodiment to realize the above-described functions. The present routine is assumed to be implemented in parallel with the above-described routine shown in FIG. 5 or 8.

the routine shown in FIG. 9, the ECU 100, first, determines whether switching of the cam profiles of the cams 64, 66, which drive the second exhaust valve 44 of the each cylinder, is required based on the deviation of the target boost pressure against the actual boost pressure (step 300).

When it is determined that switching of the cam profiles of the cams 64, 66 is required, which drive the second exhaust valve 44 (Yes in step 300), the ECU 100 implements switching of the cam profiles that drive the second exhaust valves 44 and, at the same time, adjusts the opening-closing timing of the intake valves 34 with the intake variable valve mechanism 36 (step 302).

FIGS. 10A to 10E show a time chart representing an example of process in the step 302 of the routine shown in FIG. 9. The example shown in FIGS. 10A to 10E is an example of a control during acceleration. In this case, as shown in FIGS. 10D and 10E, the exhaust flow rate increases with the increase in engine revolution speed and, therefore the turbine revolution speed rises, thereby increasing the boost pressure.

In the example shown in FIGS. 10A to 10E, the cam that drives the second exhaust valve 44 is switched from the small cam 64 to the medium cam 62 to decrease the turbine revolution speed at the point where the boost pressure reaches the target value thereof, as shown in FIG. 10C. When such a switching of the cam profile is performed, the boost pressure temporarily decreases, as shown in FIG. 10D.

A waveform shown in FIG. 10B represents changes in the advance angle amount (intake VVT advance angle) of opening-closing timing (open valve phase) of the intake valve 34. As shown in FIG. 10B, the opening-closing timing of the intake valve 34 is basically delayed as the boost pressure increases to enlarge the intake air amount (amount of air filling the cylinder). However, although such a switching of the cam profile decreases the boost pressure, while the opening-closing timing of the intake valve 34 is kept the same, the intake air amount is decreased by the blow-through of the intake air into the intake port 32.

In the process of the step 300, the opening-closing timing of the intake valve 34 is advanced simultaneously with the switching of the cam profile, as shown in FIG. 10B, to avoid such a decrease in the intake air amount. As shown in FIG. 10A, with such a control, it is possible to restrict variation of the boost pressure, thereby preventing the occurrence of difference in the intake air filling efficiency when the cam profile is switched.

More specifically, a value corresponding to the operational state of the internal combustion engine 10 can be used as the advance angle amount of the opening-closing timing of the intake valve 34, considering the relationship between the advance angle amount and the variation mode of the cam profile. However, in certain operation modes of the internal combustion engine 10, the opening-closing timing of the intake valve 34 is not limited to that with a constantly advanced angle, as in the example shown in FIGS. 10A to 10E. In contrast with the example shown in FIGS. 10A to 10E, in the case in which the boost pressure rises due to the switching of the cam profile of the second exhaust valve 44, as in. the case of switching from the medium cam 62 to the small cam 64, the advance angle amount of opening-closing timing of the intake valve 34 is adjusted to decrease the intake air amount simultaneously with the switching of the cam profile in the step 300.

With the above-described routine shown in FIG. 9, by adjusting the opening-closing timing of the intake valve 34 by the intake variable valve mechanism 36 simultaneously with switching of the cam profiles of the cams 64, 66, which drive the second exhaust valve 44, it is possible to impart a continuous intake air amount control even when the cam profiles are switched. When such switching of the cam profiles is performed without the control of the intake valve 34 implemented in the present embodiment, it causes the decrease in boost pressure, variations in pump loss caused by back pressure variations, and variations in combustion state that accompany variations in residual gas amount. The effect of such back pressure variations and variations in combustion state are eventually reflected in the output values of the internal combustion engine.

In contrast with the above-described procedure, because the continuity of intake air amount is maintained by the procedure of the present embodiment, the intake air amount can be adjusted so as to cancel the variety of effects accompanying such switching of the cam profiles. As a result, the performance of the internal combustion engine 10 and operability during transient operation can be further improved with respect to those of the above-described second embodiment.

In the above-described third embodiment, the advance angle amount of opening-closing timing of the intake valve 34 is adjusted by the intake variable valve mechanism 36 simultaneously with the switching of the earn profiles of the second exhaust valve 44. However, the control of valve opening characteristics of the intake valve implemented simultaneously with the switching of the cam profiles is not limited to such an adjustment. Thus, for example, the working angle or the lift amount of the intake valve may be adjusted simultaneously with the switching of the cam profiles.

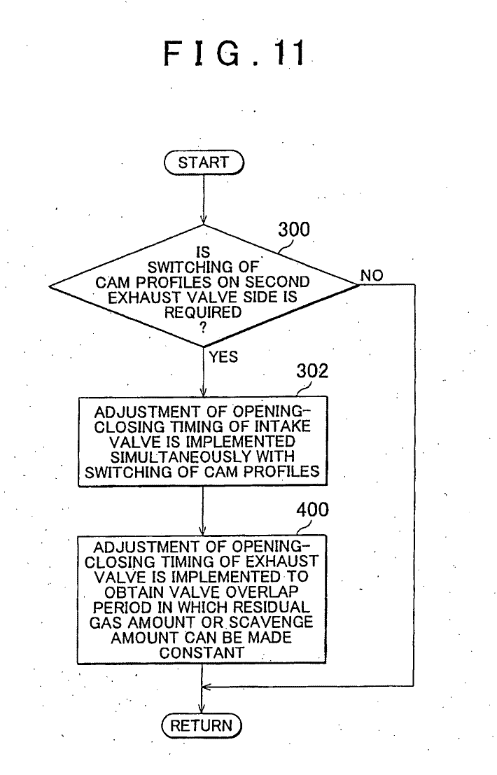

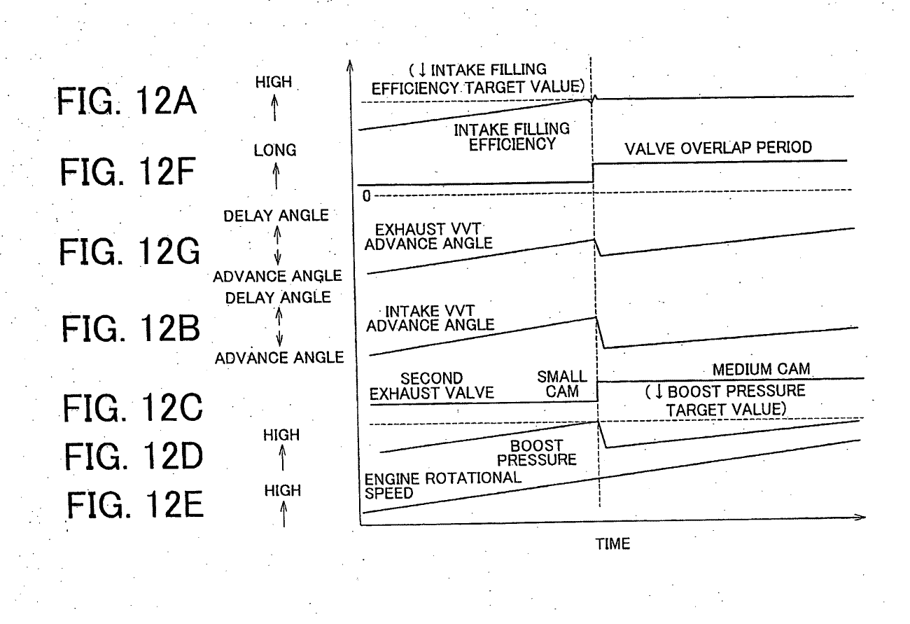

A fourth embodiment of the present invention will be explained below with reference to FIGS. 11 and 12A to 12E. The system of the present embodiment can be realized by using the hardware configuration shown in FIGS. 1 to 3A and 3B and executing the routine shown in FIG. 5^{.}or 8 and the below-descried routine shown in FIG. 11 in the ECU 100.

In the internal combustion engine equipped with a turbocharger, as in the internal combustion engine 10 of the present embodiment, where the boost pressure becomes higher than the exhaust pressure, new air is blown through into the exhaust channel. When such blow-through of the new air occurs, the residual gases within a cylinder are scavenged by the new air. Therefore, when variations in boost pressure occur, variations occur in the residual gas amount, as described hereinabove, and the blow-through amount (scavenge amount) of the new air also varies. Such variations in residual gas amount or scavenge amount cause variations in the combustion state.

In the above-described third embodiment, a procedure is explained in which by performing the adjustment of opening-closing timing of the intake valve 34 simultaneously with the switching of the cam profiles of the cams 62, 64, which drive the second exhaust valve 44, the intake air amount is adjusted to an almost fixed value and operability of the internal combustion engine 10 is ensured with respect to variations in residual gas amount or variations in boost pressure caused by the switching of the cam profiles.

However, concerning the effect produced by the variations in residual gas amount or variations in scavenge amount, if it is possible to inhibit the occurrence of such variations in residual gas amount, it would be more desirable than the cancelation thereof by the adjustment of intake air amount from the standpoint of eliminating the effect of a spread between individual parts or a spread in operation conditions. Here, a valve overlap period serves as a factor determining the residual gas amount or scavenge amount.

Accordingly, in the present embodiment, the adjustment of an advance angle amount of opening-closing timing of the exhaust valves 42, 44 is performed by the exhaust variable valve mechanism 54 when the adjustment of opening-closing timing of the intake valve 34 by the intake variable valve mechanism 36 for adjusting the boost pressure and the like is performed simultaneously with the switching of the cam profiles of the second exhaust valve 44. More specifically, the adjustment of an advance angle amount of opening-closing timing of the exhaust valve 42 etc. is performed so that the valve overlap period is basically not changed by the adjustment of opening-closing. timing of the intake valve 34 by the intake variable valve mechanism 36. Further, in certain cases, the opening-closing timing of the exhaust valve 42 etc. is adjusted in response to the adjustment of opening-closing timing of the intake valve 34 so that the valve overlap amount increases or decreases in response to variations in the boost pressure.

FIG. 11 is a flowchart of the routine executed by the ECU 100 in a fourth embodiment in order to realize the above-described functions. This routine is assumed to be executed parallel to the above-described routine shown in FIG. 5 or 8. Further, in FIG. 11, the steps identical to the steps shown in FIG. 9 are assigned with identical reference symbols and the explanation thereof is omitted or simplified.

In the routine shown in FIG. 11, when the ECU 100 decides in step 300 that there is a request to switch the cam profiles of the cams 62, 64, which drive the second exhaust valve 44, the ECU 100 in step 302 implements the adjustment of opening-closing timing of the intake valve 34 by the intake variable valve mechanism 36 simultaneously with the switching of the cam profiles of the second exhaust valve 44. Furthermore, in the present routine, the ECU 100 adjusts the opening-closing timing of the second exhaust valve 42 etc. by using the exhaust variable valve mechanism 54 so as to obtain the valve overlap amount such that the residual gas amount or scavenge amount is not changed by the variations in the boost pressure accompanying the switching of the cam profiles (step 400).

FIGS. 12A to 12E show a time chart representing an example of process in the step 400 of the routine shown in FIG. 11. Similarly to the example shown in FIGS. 10A to 10E in the above-described third embodiment, the example shown in FIGS. 12A to 12E relates to a control during acceleration. In the example shown in FIGS. 12A to 12E, a waveform representing a control amount of valve overlap period shown in FIG. 12F and a waveform representing an advance angle amount (exhaust VVT advance angle) of opening-closing timing of the exhaust valve 42 etc. shown in FIG. 12G are added to the example shown in FIGS. 10A to 10E.

More specifically, in the example shown in FIGS. 12A to 12E, the opening-closing timing of the intake valve 34 is advanced, as shown in FIG. 12B, following the switching from the small cam 64 to the medium cam 62. At the same time, by advancing the opening-closing timing of the exhaust valve 42 etc. by an advance angle amount that is less than the advance angle amount of opening-closing timing of the intake valve 34 (see FIG. 12G), the control is performed such that the valve overlap period extends over that prior to the switching of the cam profiles in order to maintain a constant residual gas amount or scavenge amount, regardless of the decrease in boost pressure (see FIG. 12F).

In the example shown in FIGS. 12A to 12E, the control is performed such that the valve overlap period extends simultaneously with the switching of the cam profiles. However, for certain switching modes of the cam profiles or operation conditions of the internal combustion engine 10, it is sometimes desirable that the control be performed such that the valve overlap period be maintained constant.

With the above-described routine shown in FIG. 11, when the adjustment of opening-closing timing of the intake valve 34 by the intake variable valve mechanism 36 is performed simultaneously. with the switching of the cam profiles of the cams 62, 64, which drive the second exhaust valve 44, the residual gas amount or scavenge amount can be controlled to a fixed value by also controlling the opening-closing timing of the exhaust valve 42 etc. As a result, in contrast with the procedure in which the variations in residual gas amount and variations in scavenge amount are canceled by the adjustment of the intake air amount, the effect of a spread between individual parts or a spread in operation conditions is eliminated and, therefore the variations in combustion state during switching of the cam profiles can be effectively inhibited.

In the above-described fourth embodiment, the opening timing and closing timing of the exhaust valve 42 are changed simultaneously by the exhaust variable valve mechanism 54. However, in accordance with the present invention, a mechanism that changes at least the closing timing of the exhaust valve may be used as the mechanism for controlling the valve overlap period.

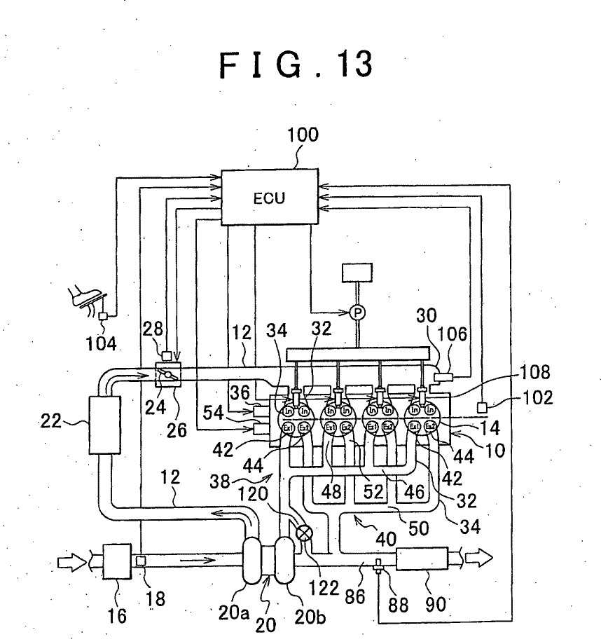

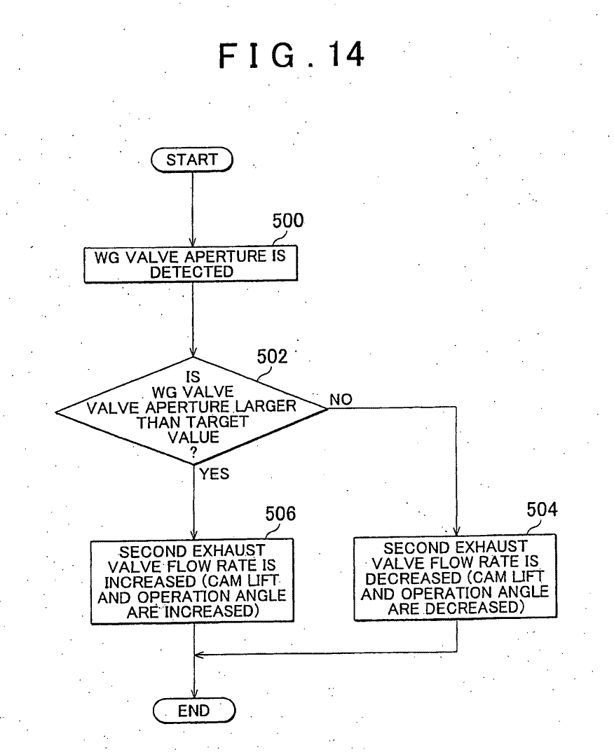

A fifth embodiment of the present invention will be explained below with reference to FIGS. 13 and 14. FIG. 13 illustrates a system configuration in the fifth embodiment of the present invention. As shown in FIG. 13, the system of the present embodiment has a configuration identical to that shown in the above-described FIG. 1, except that the system of the present embodiment includes an exhaust bypass channel 120 and a waste gate valve 122. More specifically, the exhaust bypass channel 120 is connected, as a channel bypassing the turbine 20b and connecting an inlet side and an outlet side of the turbine 243b, to the first exhaust channel 38. Further, the waste gate valve 122 is disposed in the intermediate section of the exhaust bypass channel 120.

In order to perform the procedure of adjusting the boost pressure by the switching of the cam profiles in the above-described first to fourth embodiments, it is necessary to detect the boost pressure, perform calculations with the ECU 100, and operate a valve system actuator (hydraulic cam switching mechanism 56). For this reason, the method for adjusting the boost pressure by the switching of the cam profiles is sometimes inferior, in terms of control responsiveness and stability, to the adjustment method using the waste gate valve 122, which has a valve aperture directly controlled based on the boost pressure.

Accordingly, it is also possible to consider performing fine adjustment of exhaust flow rate by using the waste gate valve 122, while performing rough adjustment of exhaust flow rate by adjusting the cam profile. However, the following problem arises when such two adjustments are performed together (in other words, when the exhaust flow rate in the second exhaust channel 40 that is not connected to the turbine 20b is decreased more than necessary). The exhaust temperature or exhaust pressure (back pressure) in the first exhaust channel 38, which is connected to the turbine 20b, rises. Therefore, when the aperture of the waste gate valve 122 becomes too large, the peak value of the exhaust pulsations during blow-down necessary to efficiently drive the turbocharger 20, so the energy recovery efficiency at the turbine 20b decreases. As a result, it is difficult to efficiently increase the boost pressure to ensure a sufficient scavenge amount in a wide operation region.

Accordingly in the present embodiment, the switching of the cam profiles of the cams 62, 64, which drive the second exhaust valve 44, is performed correspondingly to the detected aperture of the waste gate valve 122 to obtain a good controllability of boost pressure, without excessively increasing the exhaust flow rate on the first exhaust channel 38 side.

FIG. 14 is a flow chart of the routine executed by the ECU 100 in the fifth embodiment to realize the above-described functions. In the routine shown in FIG. 14, the ECU 100 first detects an aperture of the waste gate (WG in the drawing) valve 122 (step 500). The aperture detection of the waste gate valve 122 can be performed, for example, by a process of comparing an estimated value of boost pressure and an actual value of boost pressure based on the relationship between the load ratio and engine revolution speed of the internal combustion engine 10.

Then, the ECU 100 determines whether the detected aperture of the waste gate valve 122 is larger than a predetermined target value (step 502). The target value of the waste gate valve aperture in this step 502 is set to a value such that the exhaust flow rate can be adjusted, if possible, without relying on the waste gate valve 122. More specifically, the target value is set such that the ratio of the adjustment of exhaust flow rate performed by the waste gate valve 122 to the total flow rate adjustment margin combining the flow rate adjustment performed by the waste gate valve 122 and the flow rate adjustment performed by the switching of the cam profiles is about 10%.

When it is determined in the step 502 that the aperture of the waste gate valve 122 is equal to or less than the target value (No in step 502), the ECU 100 determines that there is a margin for adjusting the aperture of the waste gate valve 122. Therefore, in this case, the small cam 64 is selected as the cam for driving. the second exhaust valve 44 so that the exhaust flow rate on the side of the first exhaust channel 38 connected to the turbine 20b be increased (in other words, the exhaust flow rate on the second exhaust channel 30 side is dm-teased) (step 504).

On the other hand, when it is determined in the step 502 that the aperture of the waste gate valve 122 is larger than the target value. (Yes in step 502), the ECU 100 determines that a state, in which the supply of exhaust gas to the waste gate valve 122 exceeds the expected value, is assumed. Therefore, in this case, the medium cam 62 is selected as the cam for driving the second exhaust valve 44 so that the exhaust flow rate on the side of the second exhaust channel 40, which is not connected to the turbine 20b, is increased (step 506).

With the above-described routine shown in FIG. 14, the aperture of the waste gate valve 122 can be feedback controlled so that the aperture can be maintained at a target small value, by performing both the boost pressure adjustment by the switching of the cam profiles and the boost pressure adjustment by the aperture adjustment of the waste gate valve 122. Therefore, the decrease in the efficiency of energy recovery of the turbine, caused by controlling the .waste gate valve aperture to an excessively large value, can be prevented and scavenging can be performed within a wide range of operation region of the internal combustion engine 10.

In the above-described fifth embodiment, the exhaust variable valve mechanism 54 is explained as a mechanism that switches the lift amount and working angle of the second exhaust valve 44 in stages (two stages). However, in contrast with the above-described first to fourth embodiments to the fifth embodiment, the configuration of the exhaust variable valve mechanism is not limited to such a mechanism. For example, the lift amount and working angle of the second exhaust valve 44 also may be switched in a stageless manner.

In the above-described first to fifth embodiments, the cam profiles of the cams 62, 64, which drive the second exhaust valve that opens and closes the second exhaust channel 40 that is not connected to the turbine 20b, are switched. However, according to the present invention, the exhaust valve having valve opening characteristics that controls the amount of exhaust energy supplied to the turbine, as well as the turbine revolution speed and boost pressure, is not limited to the second exhaust valve. It may be the other exhaust valve 42, that is, the first exhaust valve 42 connected to the turbine 20b.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A control device for an internal combustion engine equipped with a turbocharger, wherein the internal combustion engine comprising:
a turbocharger that pressure-charges an intake air;
a first exhaust channel connected to a turbine of the turbocharger;
a first exhaust valve that opens and closes the first exhaust channel;
a second exhaust channel that is not connected to the turbine;
a second exhaust valve that opens and closes the second exhaust channel;
an exhaust variable valve mechanism that can change a valve opening characteristic of one of the first exhaust valve and the second exhaust valve, that is the exhaust valve subjected to be switched; and
a control portion that adjusts an amount of exhaust energy supplied to the turbine,
wherein the exhaust variable valve mechanism has a cam, that has a plurality of cam profiles, drives the exhaust valve subjected to be switched,
wherein the exhaust variable valve mechanism can switch the plurality of cam profiles in stages, and
wherein the control portion adjusts the amount of exhaust energy supplied to the turbine by switching the plurality of cam profiles.

2. The control device for an internal combustion engine equipped with a turbocharger according to claim 1, wherein the internal combustion engine further includes:
an exhaust bypass channel that bypasses the turbine and connects an inlet side of the turbine and an outlet side of the turbine; and
a waste gate valve disposed in an intermediate section of the exhaust bypass channel, wherein the control portion switches the plurality of cam profiles so that an exhaust gas flow rate on the second exhaust channel side increases when an opening degree of the waste gate valve is larger than a target opening degree by a predetermined value or more.

3. The control device for an internal combustion engine equipped with a turbocharger according to claim 1, wherein the control portion adjusts at least one of a boost pressure and a turbine revolution speed by switching the plurality of cam profiles.

4. The control device for an internal combustion engine equipped with a turbocharger according to claim 1, wherein the switching of the plurality of cam profiles in stages is performed either in a plurality of stages or in a stageless manner.

5. The control device for an internal combustion engine equipped with a turbocharger according to claim 1, wherein:
the internal combustion engine has a plurality of cylinders;
the exhaust variable valve mechanism has the plurality of cam profiles for each exhaust valve subjected to be switched in the each cylinder;
the exhaust variable valve mechanism is configured to be capable of switching the plurality of cam profiles in stages for the each cylinder; and
the control portion adjusts an exhaust flow rate on the first exhaust channel side by changing the number of cylinders in which the switching of the plurality of cam profiles is performed.

6. The control device for an internal combustion engine equipped with a turbocharger according to claim 5, wherein the switching of the plurality of cam profiles in stages is performed in two stages.

7. The control device for an internal combustion engine equipped with a turbocharger according to claim 5, wherein the plurality of cylinders have the same plurality of cam profiles.

8. The control device for an internal combustion engine equipped with a turbocharger according to claim 5, wherein:
at least two cylinders in the plurality of cylinders have different plurality of cam profiles; and
the control portion adjusts the exhaust flow rate on the first exhaust channel side by selecting the cylinders in which the switching of the plurality of cam profiles is performed, or by changing the number of cylinders.

9. The control device for an internal combustion engine equipped with a turbocharger according to claim 1, wherein the internal combustion engine further includes an intake variable valve mechanism that can change a valve opening characteristic of an intake valve,
wherein the control portion performs an adjustment of an intake air amount to the internal combustion engine by using the intake variable valve mechanism, simultaneously with the switching of the plurality of cam profiles.

10. The control device for an internal combustion engine equipped with a turbocharger according to claim 9, wherein the intake variable valve mechanism controls any one or more from among an opening-closing timing, a lift amount, and a working angle of the intake valve.

11. The control device for an internal combustion engine equipped with a turbocharger according to claim 9, wherein:
the exhaust variable valve mechanism is further configured to be capable of changing a closing time of at least one of the first exhaust valve and the second exhaust valve; and
the control portion performs an adjustment of a valve overlap period by using the exhaust variable valve mechanism so that at least one of a residual gas amount and scavenge amount inside a cylinder are maintained at a fixed value when the adjustment of the intake air amount using the intake variable valve mechanism is implemented.

12. The control device for an internal combustion engine equipped with a turbocharger according to claim 9, wherein:
the exhaust variable valve mechanism is further configured to be capable of changing an opening-closing timing of at least one of the first exhaust valve and the second exhaust valve; and
the control portion performs an adjustment of a valve overlap period by using the exhaust variable valve mechanism so that at least one of a residual gas amount and scavenge amount inside a cylinder are maintained at a fixed value when the adjustment of the intake air amount using the intake variable valve mechanism is implemented.

13. The control device for an internal combustion engine equipped with a turbocharger according to claim 9, wherein:
the exhaust variable valve mechanism is further configured to be capable of changing an opening-closing timing of at least one of the first exhaust valve and the second exhaust valve;
the intake variable valve mechanism is further configured to be capable of changing an opening-closing timing of the intake valve; and
the control portion performs an adjustment of a valve overlap period so that at least one of a residual gas amount and scavenge amount inside a cylinder are maintained at a fixed value when the adjustment of the valve overlap period using the intake variable valve mechanism and the exhaust variable valve mechanism is implemented.
